(19) United States
(12) Patent Application Publication
(10) Pub. No.: US 2011/0102111 A1
(43) Pub. Date: May 5, 2011

(54) BAND-PASS FILTER CIRCUIT WITH TRANSMISSION LINES

(75) Inventor: WEN-CHUNG WANG, Tu-Cheng (TW)

(73) Assignee: HON HAI PRECISION INDUSTRY CO., LTD., Tu-Cheng (TW)

(21) Appl. No.: 12/637,761

(22) Filed: Dec. 15, 2009

(30) Foreign Application Priority Data
Oct. 29, 2009 (CN) 200910309042.2

(51) Int. Cl. H01P 1/203

(52) U.S. Cl. 333/204

(57) ABSTRACT

A band-pass filter circuit with transmission lines includes an input end and an output end connected by a transmission line circuit. The input end is configured for inputting signals into the band-pass filter circuit. The output end is configured for outputting the filtered signals to other devices. The transmission line circuit includes a microstrip transmission line and a number of shorted transmission lines parallel to each other. An end of each shorted transmission line is connected to the microstrip transmission line, and the other end of each shorted transmission line is grounded. Both the microstrip transmission line and the shorted transmission lines are quarter wavelength lossless transmission lines and the phase difference in signal transmission is π/2.

### BACKGROUND

1. Technical Field

The present disclosure relates to band-pass filters and, particularly, to a band-pass filter circuit with transmission lines.

2. Description of Related Art

An ideal band-pass filter should have a completely flat pass-band, with no gain or loss therein, with frequencies outside the pass-band having been completely lost.

A conventional band-pass filter circuit is structured by combining a high-pass circuit structure and a low-pass circuit structure. In addition, the conventional band-pass filter often includes conventional electronic components, which are bulky and incur insertion and return loss in the pass-band because they need to be welded onto the printed circuit board thereof. The result is a bulky structure with poor performance.

Additionally, a conventional band-pass filter is electronically grounded via a conventional capacitor or inductor and installation and residual welding stress impairs quality factor (Q factor), such that the band-pass filter performance is further reduced.

Therefore, it is desirable to provide a band-pass filter, which can overcome or at least alleviate the limitations described.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a band-pass filter circuit with transmission lines, according to an exemplary embodiment.

FIG. 2 is an equivalent circuit view of the band-pass filter circuit of FIG. 1.

FIG. 3 is an oscillogram of an insertion loss (IL) and a return loss (RL) acting on a pass-band of the band-pass filter circuit of FIG. 1.

FIG. 4 is an oscillogram of a decay (A) acting outside the pass-band of the band-pass filter circuit of FIG. 1.

### DETAILED DESCRIPTION

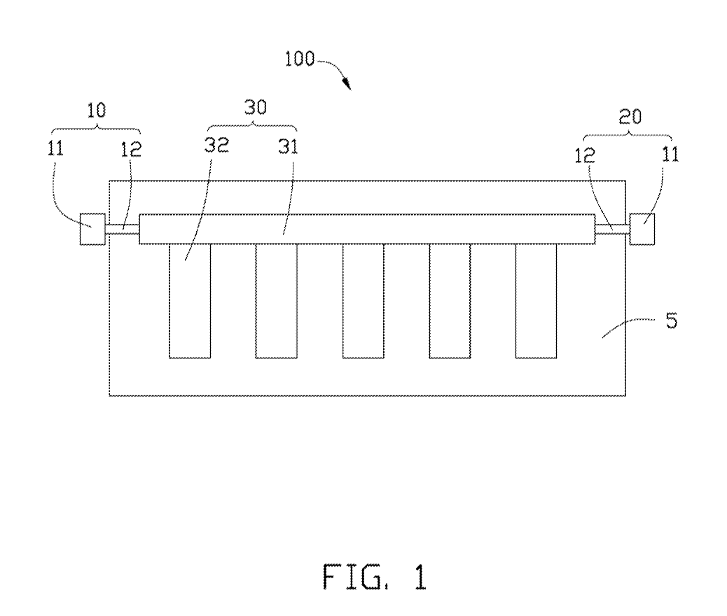

Referring to FIG. 1, a band-pass filter circuit 100 with transmission lines includes an input end 10 and an output end 20 connected by transmission line circuit 30.

The input end 10 is configured for inputting electromagnetic signals. The output end 20 is configured for outputting filtered electromagnetic signals. In this embodiment, each of the input end 10 and the output end 20 includes a connector 11 connected to the transmission line circuit 30 via a metal line 12.

The transmission line circuit 30 includes a microstrip transmission line 31 and five shorted transmission lines 32. The shorted transmission lines 32 are parallel to each other and an end of each shorted transmission line 32 is connected to the microstrip transmission line 31, and the other end of each shorted transmission line 32 is grounded. Thus all the shorted transmission lines 32 are shorted or short-circuited to ground. In this embodiment, the main material of transmission line circuit 30 is copper. The microstrip transmission line 31 is a continuous strip. The five shorted transmission lines 32 are commensurate with each other.

Both the microstrip transmission line 31 and the shorted transmission lines 32 are quarter wavelength lossless transmission lines with phase difference during signal transmission of π/2. The input impedance of the shorted transmission lines 32 satisfies a formula: Zin=jZ0 tan β1, wherein, Zin is an input impedance of the band-pass filter circuit 100, Z0 is a characteristic impedance of the band-pass filter circuit 100, β is a phase constant, and 1 is the length of a shorted transmission lines 32. Therefore, when β is π/2 in this embodiment, Zin is infinite. As a common theory, with increased input impedance of the shorted transmission lines 32, signal transmission efficiency of the shorted transmission lines 32 grows correspondingly. Thus, the shorted transmission lines 32 can enhance efficiency in transmitting the signals.

The shorted transmission line 32 is printed on a substrate 5 and connected to the microstrip transmission line 31 by chemical plating. Therefore, because the shorted transmission lines 32 can be integrally formed with the microstrip transmission line 31 by chemical plating, installation and residual welding stress thereon are less than circuits with electronic components. Quantity factor of the shorted transmission line 32 is improved and the band-pass filter circuit 100 improves filtering performance with a better quantity factor thereof.

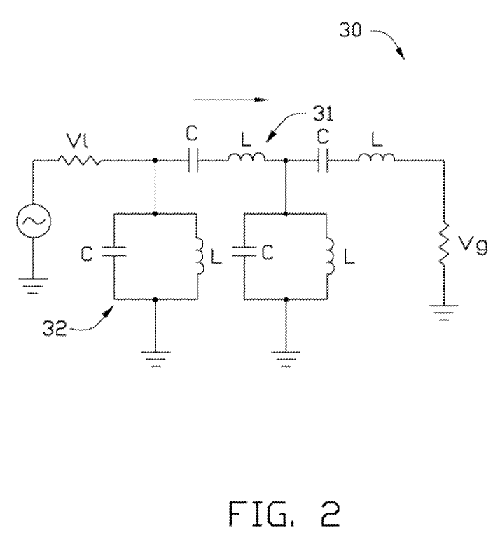

Referring to FIG. 2, the transmission line circuit 30 is divided into fourth-order circuits in this embodiment. It will be understood that the quantity of the shorted transmission line 32 can vary in different cases.

The microstrip transmission line 31 is configured for transmitting signals in the pass-band and the shorted transmission lines 32 are configured for transmitting the signals outside the pass-band to ground. Specifically, the microstrip transmission line 31 functions as inductance L and capacitance C in series. Therefore, two L-C resonant loops in series can be formed in the microstrip transmission line 31. A resonant frequency fr of the L-C resonant loop in series can be designed according to the inductance L and capacitance C thereof. Each shorted transmission line 32 functions as inductance L and capacitance C in parallel. Therefore, an L-C resonant loop in parallel can be formed in each shorted transmission line 32. A resonant frequency fr of the L-C resonant loop in parallel can also be designed according to the inductance L and capacitance C thereof. The resonant frequency of the L-C circuits fr is predetermined between a low frequency f_{L} and an upper frequency f_{H}. When a signal in frequency fr is inputted, the impedance of the L-C resonant loops in series is zero and the impedance of the L-C resonant loops in parallel is infinite, so that the signals can be transmitted with pronounced efficiency to the output end 11. When the frequency of the input signal is lower than the low frequency f_{L}, the shorted transmission lines 32 will function as an inductor, so that the lower frequencies will be shorted to ground. When the frequency of the input signal is higher than the upper frequency f_{H}, the shorted transmission lines 32 will function as capacitor, so that the higher frequencies will be shorted to ground. Therefore, the band-pass filter circuit 100 can transmit signals in pass-band and reject signals outside the pass-band.

Further, the size (width and thickness) of the microstrip transmission line 31 and each shorted transmission line 32 can be easily designed by an advanced design system (ADS) or computer-aided engineering (CAE), due to a predetermined impedance of the shorted transmission line 32. The performance of the transmission line circuit 30 also can be simulated by the ADS or the CAE, to reach a designed target.

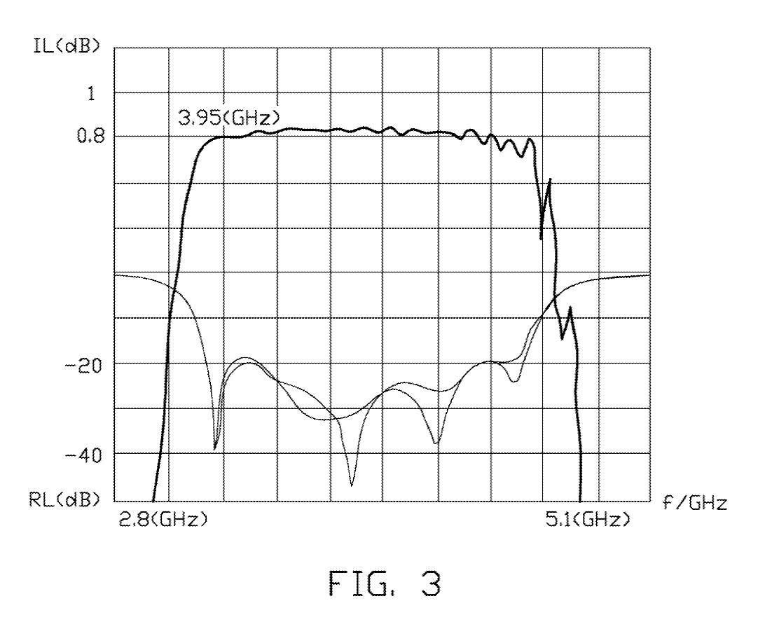

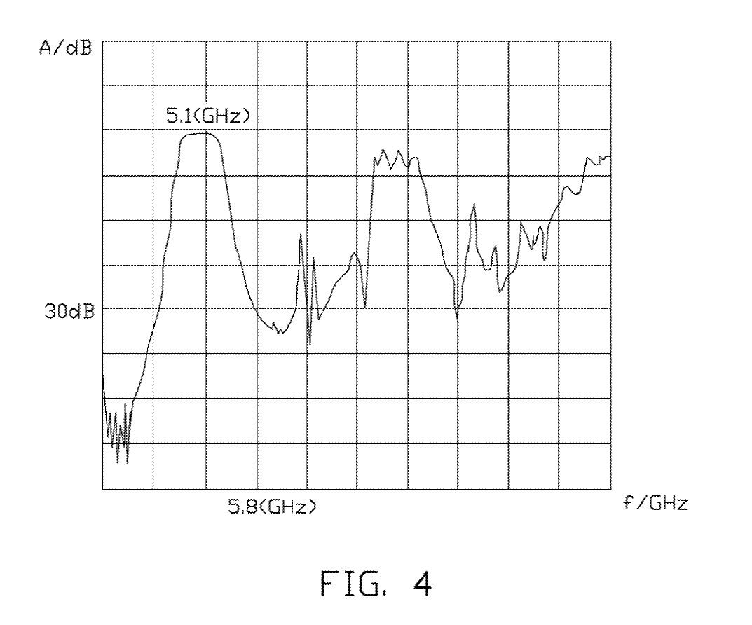

Referring to FIGS. 3 and 4, the capabilities of the band-pass filter circuit 100 with transmission lines can be better understood by measuring the performance of a Chebyshev band-pass filter with the band-pass filter circuit 100. The measuring results are shown as oscillograms. In this embodiment, a proposed pass-band of the Chebyshev band-pass filter is a cut off frequency from 3.1 GHz to 4.8 GHz.

According to the measuring results, we can see that when the signals are transmitted in the pass-band via the band-pass filter circuit 100, the insertion loss (IL) is less than 0.82 dB and the return loss (RL) is less than 20 dB. When the signal frequency is 5.8 GHz, the decay (A) of the signal equals or exceeds 30 dB. However, in the same conditions, a conventional filter circuit usually has an insertion loss (IL) larger than 1 dB and a decay (A) less than 30 dB. That is to say, the band-pass filter circuit 100 with transmission line can obtain better performance in transmitting signals than the conventional filter circuit.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A band-pass filter circuit with transmission lines comprising:
an input end configured for inputting signals into the band-pass filter circuit;
an output end configured for outputting the filtered signals; and
a transmission line circuit connecting the input end to the output end, the transmission line circuit comprising a microstrip transmission line and a plurality of shorted transmission lines parallel to each other, an end of each shorted transmission line connected to the microstrip transmission line, and the other end of each shorted transmission line grounded, wherein both the microstrip transmission line and the shorted transmission lines are quarter wavelength lossless transmission lines and the phase difference during signal transmission is π/2.

2. The band-pass filter circuit with transmission lines of claim 1, wherein each of the input end and the output end comprises a connector connected to the transmission line circuit via a metal line.

3. The band-pass filter circuit with transmission lines of claim 1, wherein the transmission line circuit is printed on a substrate by chemical plating.

4. The band-pass filter circuit with transmission lines of claim 1, wherein the transmission line circuit comprises five shorted transmission lines.

5. The band-pass filter circuit with transmission lines of claim 1, wherein the input impedance of the microstrip transmission line is infinite.

6. The band-pass filter circuit with transmission lines of claim 1, wherein the transmission line circuit is divided into fourth-order filtering circuits.

7. The band-pass filter circuit with transmission lines of claim 1, wherein the size (width and thickness) of each shorted transmission line is designed by advanced design system (ADS) or computer-aided engineering (CAE), due to a predeterminded impedance of the shorted transmission line.
